(19) United States
(12) Patent Application Publication
(10) Pub. No.: US 2019/0045454 A1
(43) Pub. Date: Feb. 7, 2019

(54) METHOD AND APPARATUS FOR COEXISTENCE OF A V2X SAFETY CHANNEL WITH OTHER CHANNELS

(71) Applicant: AUTOTALKS LTD., Kfar Netter (IL)

(72) Inventors: Onn Haran, Bnei Dror (IL); Ariel Feldman, Ra'anana (IL)

(21) Appl. No.: 15/793,331

(22) Filed: Oct. 25, 2017

Related U.S. Application Data
(60) Provisional application No. 62/540,788, filed on Aug. 3, 2017.

(51) Int. Cl. H04W 52/24; H04L 5/00; H04W 72/08

(52) U.S. Cl. CPC H04W 52/243; H04W 16/14; H04W 72/082; H04L 5/0055

(57) ABSTRACT

Method and apparatus for mitigating interference between two channels in vehicle-to-everything (V2X) communications. A method includes activating two, first and second communication channels in a vehicle, and mitigating interference when the two channels operate concurrently. The first communication channel may be a V2X safety channel and the second communication channel may be a WiFi or V2X non-safety channel. Apparatus used to perform the method includes an interface between two, first and second modems, each modem coupled through two transceivers to two antennas, the interface used for coordinating between the first and second modems to mitigate interference between the first communication channel and the second communication channel.

### CROSS REFERENCE TO RELATED APPLICATIONS

This application is related to and claims priority from U.S. Provisional Patent Application 62/540,788 filed Aug. 3, 2017, which is incorporated herein by reference in its entirety.

### FIELD

Embodiments disclosed herein relate in generally to vehicle-to-everything (V2X) communications and in particular to coexistence of a V2X safety channel with other communication channels in a V2X environment. The term “vehicle” has its commonly used and understood meaning.

### BACKGROUND

In known V2X communications, one channel of a V2X band is defined as a “safety channel”. The V2X safety channel promises to increase the level of vehicle safety by enabling reliable and early alerts of dangerous situations. At present, the V2X band includes 3 channels in Europe and 7 channels in USA. Expansion of the use of other (existing or additional) V2X channels (also referred to herein as “service” or “non-safety” V2X channels) is needed to support other services such as vehicle-to-infrastructure (V2I) or automated driving, but the V2X safety channel operation cannot be allowed to be affected by such expansion.

The V2X safety channel needs to operate concurrently with other V2X channels and with WiFi, because it needs to remain functional whenever the vehicle is in operation. One challenge is that the V2X safety channel, other V2X channels and 5 GHz WiFi use similar frequencies: WiFi uses the entire 5 GHz band, while V2X channels occupy the 5.9 GHz band. At present, WiFi is mostly used for in-vehicle data distribution, yet its usage should expand to external vehicle communication. In contrast with cellular communication, WiFi allows free data connectivity. This fits well most applications, like diagnostics, firmware upgrade or data upload, which can settle for sporadic connectivity.

WiFi includes embedded mechanisms that may be used for its protection. As used herein, the term “protection” refers to un-degraded operation of one channel in the presence of activity by other channel. These mechanisms are not supported by the V2X safety channel, which needs to be used only for safety messages. Similarly, other V2X channels are not used in the typical configuration of device and access-point. The coordination of communication between the V2X safety channel and another V2X or WiFi channel is more complicated.

Dual-antenna installations in vehicles are known, see e.g. FIG. 1, which illustrates a known dual-antenna installation model (configuration) in a vehicle 100. Vehicle 100 has a front antenna 110 and a rear antenna 112, to cover all directions. The V2X safety channel and the other channel (WiFi or V2X) use both antennas. The operation of a dual-antenna is more complicated than that of a single antenna, because it has to deal with diversity.

The transmissions of one channel may be affected by interference from another channel. The term “interference” refers to a combination of two parameters: a) added out-of-band noise injected by a transmitter of one (e.g. “first”) channel into the band of another (e.g. “second”) channel, and b) impact of the in-band power of the second channel on the reception circuitry of the first channel. The impact of interference is expressed in the reduction of receive sensitivity of one channel due to noise created by transmission of another channel. Each communications receiver has a parameter called “adjacent channel rejection” that defines its ability to sustain such interference. The parameter defines the maximal energy difference between channels that will reduce sensitivity by 3 dB. When this difference (gap) is exceeded, the sensitivity is reduced reduces dramatically.

One known solution for enabling concurrent operation of a V2X safety channel with other V2X channels and with WiFi is based on adding dedicated antennas to ensure isolation between the V2X safety channel and the other channels. As used herein, the term “isolation” refers to an amount of signal power reduction. With this solution, some antennas are dedicated to the V2X safety channel and some to WiFi and/or other V2X channels. If two antennas are needed for each channel to assure 360° connectivity, then overall four antennas would be needed for the V2X channel and one other channel. The number of antennas in a vehicle is limited due to vehicle aesthetics and associated costs: having four antennas in a vehicle is highly unlikely. Further, this solution does not ensure that other nearby vehicles will not degrade V2X safety performance. Achieving required isolation between four antennas is very challenging, and the operation of four antennas can interfere with communications of other vehicles as well.

There is therefore a need for, and it would be advantageous to have coexistence schemes between the V2X safety channel and a WiFi channel and/or other V2X channels, and to protect the V2X safety channel and other communication links when sharing antennas (i.e. to mitigate interference between channels).

### SUMMARY

Embodiments disclosed herein relate to apparatus and methods for coexistence of a V2X safety channel (also referred to simply as “safety channel”) with other communication channels in a V2X environment. As used herein, the term “coexistence” as applied to two (first and second) different channels in V2X communications refers to dual-channel operation with mitigated interference.

The apparatus and methods provide protection of the V2X safety channel without significantly degrading other channels even when sharing antennas. The interference between two channels is significantly mitigated using an inventive interface between two modems, wherein each modem is coupled operatively to both antennas. The term “significantly mitigated interference” means that the maximal allowed sensitivity degradation of a channel is at most 3 dB and/or that the Packet Error Rate (PER) of safety messages is equal to or less than 10%, given that this PER is achievable without interference. The interface is used by various coordination schemes.

In exemplary embodiments, apparatus and methods disclosed herein share the same antennas for both a V2X safety channel and for a second V2X channel or WiFi, while optimizing WIFI throughput and protecting V2X safety channel operation.

In exemplary embodiments, there are provided methods comprising: in a vehicle, activating two communication channels and mitigating interference between the two channels when the two channels operate concurrently.

In an exemplary method embodiment, the activating two communication channels includes activating a V2X safety channel and a WiFi channel.

In an exemplary method embodiment, the mitigating interference between the two channels includes protecting reception in the V2X safety channel from transmission in the WiFi channel.

In an exemplary method embodiment, the mitigating interference between the two channels includes protecting reception in the WiFi channel from transmission in the V2X safety channel.

In an exemplary method embodiment, the activating two communication channels includes activating a V2X safety channel and a V2X non-safety channel.

In an exemplary method embodiment, the mitigating interference between the two channels includes protecting reception in the V2X non-safety channel from transmission in the V2X safety channel.

In an exemplary method embodiment, the mitigating interference between the two channels includes protecting reception in the V2X safety channel from transmission in the V2X non-safety channel.

In an exemplary method embodiment, the protecting reception in the V2X safety channel from transmission in the WiFi channel includes transmitting a WiFi ACK message at a power lower than a maximal possible power adjusted to a modulation signal-to-noise (SNR) gap.

In an exemplary method embodiment, the protecting reception in the V2X safety channel from transmission in the WiFi channel includes selecting dynamically an antenna for WiFi channel transmission.

In an exemplary method embodiment, the protecting reception in the V2X safety channel from transmission in the WiFi channel includes selectively stopping WiFi operation.

In an exemplary method embodiment, the protecting reception in the WiFi channel from transmission in the V2X safety channel includes using a power-save mode in WiFi operation during an expected V2X safety channel transmission

In an exemplary method embodiment, the protecting reception in the V2X non-safety channel from transmission in the V2X safety channel includes aligning a transmission in the V2X non-safety channel transmission with the transmission in V2X safety channel.

In an exemplary method embodiment, the protecting reception in the V2X non-safety channel from transmission in the V2X safety channel includes aligning a transmission in the V2X non-safety channel with a V2X safety channel transmission of another vehicle that does not use an opportunity to transmit in the V2X non-safety channel.

In an exemplary method embodiment, the protecting reception in the V2X non-safety channel from transmission in the V2X safety channel includes fragmenting a V2X non-safety channel transmitted packet to match a length of a V2X safety channel transmitted packet.

In an exemplary embodiment there is provided an apparatus, comprising: a first modem coupled operatively to a first communication channel, a second modem coupled operatively to a second communication channel, a first transceiver and a second transceiver coupled operatively to the first modem and used to perform RF modulation of the first communication channel to a first antenna and to a second antenna, a third transceiver and a fourth transceiver coupled operatively to the second modem and used to perform RF modulation of the second communication channel to the first antenna and the second antenna, and an interface for coordinating between the first and second modems to mitigate interference between the first communication channel and the second communication channel.

In an exemplary apparatus embodiment, the first communication channel includes a V2X safety channel, the second communication channels includes a WiFi channel or a V2X non-safety channel and the interface includes an attribute sent from the first modem to the second modem.

In an exemplary apparatus embodiment, the mitigating interference between the two channels includes protecting reception in the V2X safety channel from transmission in the WiFi channel.

In an exemplary apparatus embodiment, the mitigating interference between the two channels includes protecting reception in the WiFi channel from transmission in the V2X safety channel.

In an exemplary apparatus embodiment, the mitigating interference between the two channels includes protecting reception in the V2X non-safety channel from transmission in the V2X safety channel.

In an exemplary apparatus embodiment, the protecting reception in the V2X non-safety channel from transmission in the V2X safety channel includes aligning a transmission in the V2X non-safety channel transmission with the transmission in V2X safety channel.

### BRIEF DESCRIPTION OF THE DRAWINGS

Non-limiting examples of embodiments disclosed herein are described below with reference to FIG. s attached hereto that are listed following this paragraph. The drawings and descriptions are meant to illuminate and clarify embodiments disclosed herein, and should not be considered limiting in any way. Like elements in different drawings may be indicated by like numerals.

FIG. 1 illustrates a known dual-antenna installation model (configuration) in a vehicle;

FIG. 2A illustrates a centralized dual-channel dual-antenna apparatus, according to an exemplary embodiment;

FIG. 2B illustrates a distributed dual-channel dual-antenna apparatus, according to an exemplary embodiment;

FIG. 2C illustrates a flow diagram of dual-channel operation with mitigated interference, according to an exemplary embodiment;

FIG. 3 illustrates a message flow of protected WiFi operation in a power-save handshake scenario, according to an exemplary embodiment;

FIG. 4 depicts simulation results of WiFi coexistence with V2X channel operation, according to an exemplary embodiment;

FIG. 5 illustrates a flow diagram of WiFi TX antenna selection according to an exemplary embodiment;

FIG. 6 illustrates a flow diagram of selective stoppage of WiFi operation, according to an exemplary embodiment;

FIG. 7 illustrates a message flow of V2X safety and service channels, according to an exemplary embodiment;

FIG. 8 illustrates a flow diagram of V2X service channel transmission, according to an exemplary embodiment.

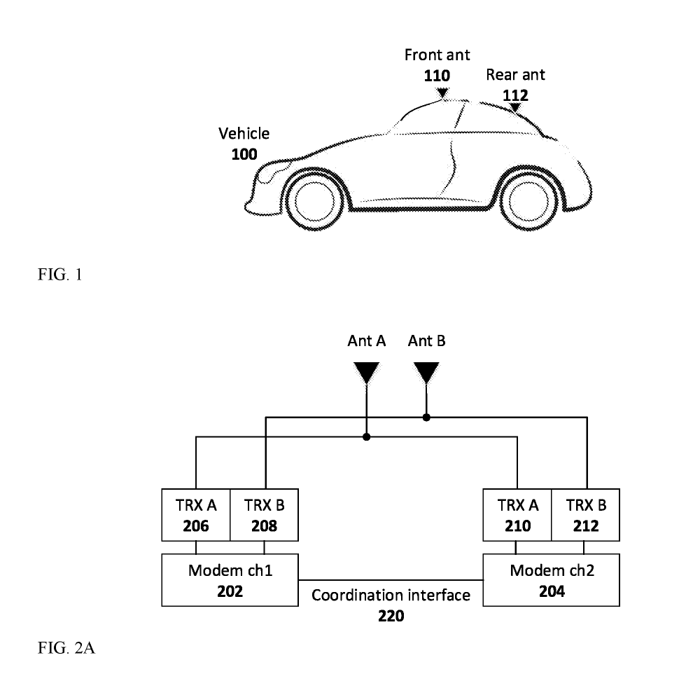

### DETAILED DESCRIPTION

In V2X communications, a dual-antenna configuration is needed for reducing interference between two different channels (e.g. a V2X safety channel and the WiFi channel, or a V2X safety channel and another V2X channel). In addition, many vehicles need a dual-antenna to allow 360° coverage around the vehicle for purposes other than reducing interference between a V2X safety channel and either a WiFi channel or another V2X channel.

The following description refers to three different protection implementation embodiments involving the V2X safety channel and another channel: protection of a WiFi channel from the V2X safety channel, protection of the V2X safety channel from a WiFi channel and protection of the V2X safety channel from other V2X channels.

### Apparatus

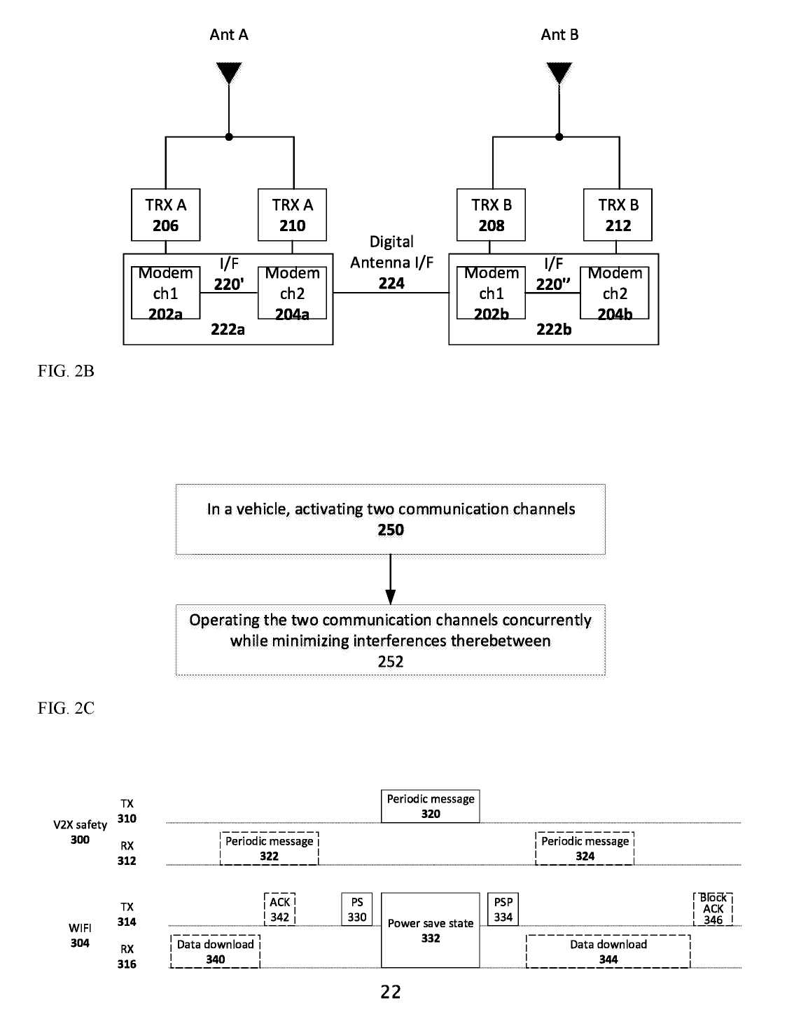

A first exemplary embodiment of an apparatus that enables coexistence of a V2X safety channel and other communications channels is described with reference to FIG. 2A. The figure illustrates a centralized dual-channel dual-antenna apparatus 100 that comprises two modems, a first modem 202 that receives and transmits packets over a first channel (channel #1) and a second modem 204 that receives and transmits packets over a second channel (channel #2) and four transceivers (TRX) 206, 208, 210 and 212. In the figure, “FE” refers to “front end”. Transceiver 206 performs RF modulation of channel #1 to a first antenna A and transceiver 208 performs RF modulation of channel #1 to a second antenna B. Transceiver 210 performs RF modulation of channel #2 to antenna A and transceiver 212 performs RF modulation of channel #2 to antenna B. Therefore, antenna A is coupled operationally to transceivers 206 and 210, and antenna B is coupled operationally to transceivers 208 and 210

Apparatus 200 further comprises an interface 220 for coordination specified between the two modems and represented by ch1 (“channel 1”) and ch2 (“channel 2”). Interface 220 transmits attributes (see below) from the V2X safety channel modem to the other modem and does not include transmit packet data. An attribute is sent to ensure the coexistence i.e. to mitigate interference. The attributes define the output of the V2X safety modem (the modem that modulates the V2X safety channel) feeding the other modem (that modulates the WiFi or V2X service channels). Inventively, interface 220 allows co-existence between communications of the safety V2X channel and a WiFi or another V2X channel. Interface 220 exchanges information between the two modems. The interface includes a number of attributes used by the protection mechanisms described below. These attributes include:
About to transmit safety: this attribute is set to true Xms (for example 2 ms) before a safety message is transmitted.
Expected transmission duration: this attribute describes the expected duration of the upcoming safety message. It is calculated based on the packet length, which can vary according to packet content.
Transmission on: this attribute is set to true when the safety message transmission is ongoing
Protected reception is expected: this attribute is set to true, Y ms (for example 2 ms) before a message that should be protected is expected to be received.
Total Packet Error Rate: this attribute is the Packet Error Rate (PER) over all received messages.
Packet Error Rate of vehicles inside protection radius: this attribute is the PER over received messages from vehicles within distance R from a self-vehicle, where R is typically 300 meters.
Antenna preferred for V2X operation: this attribute is the antenna number that should be used for current V2X reception to continue proper reception.
Strong packet is received: this attribute is set to true when the energy of current received packet is above a certain threshold, for example stronger than −55 dBm.
Duration of current received packet: this attribute is updated during the process of packet reception to indicate the duration of the received packet.

Apparatus 200 is capable of receiving from both antennas and from both channels concurrently, i.e. channel #1 is received concurrently with channel #2 and a signal is received concurrently from both antennas A and B. However, when transmission takes place from a one channel, the other channel of the same antenna is blinded and cannot operate. With proper design, the other channel could be received on the other antenna. For example, channel #1 transmits at antenna A using transceiver 206. Transceiver 210 is blinded, and cannot be used for channel #2 reception. Transceiver 212 is operable and allows reception of channel #2. Should channel #1 transmit using the two antennas, meaning transceiver 208 is active as well, then channel #2 would be completely blinded.

FIG. 2B shows another exemplary embodiment of an apparatus 200′ that that enables coexistence of a V2X safety channel and other communications channels. In apparatus 200′, each of modems 202 and 204 is split into two parts a and b. Parts 202a and 204a are then assembled into a modem 222a, and parts 202b and 204b are then assembled into a modem 222b. Modems 222a and 222b are placed at two separate locations, typically next to the respective antennas and are coupled to the respective antennas through transceivers as shown, and to each other through a digital interface 224 that allows digital connectivity between antennas, as described in co-invented and co-owned US published patent application No. 20170237474. The logical functionality is the same. Each of modems 222a or 222b can function as a coordinator as described in US 20170237474.

An apparatus such as 200 in FIG. 2A or 200′ in FIG. 2B may be used in a method to protect one channel from another.

FIG. 2C illustrates, in an exemplary embodiment, a flow diagram of dual-channel operation with mitigated interference. In step 250, in a vehicle, two communication channels are activated to perform V2X communications. The channels may include a WiFi channel, V2X safety channel, and other V2X channels. In step 252, the two activated channels are operated concurrently while interference between the two channels are mitigated. The mitigation may include protection of reception of key safety messages (i.e. safety message of vehicles with highest relevance for a safety decision) from transmissions by the other channel or channels, protection of the reception of the other channel or channels from transmissions by the safety channel or both. Some of the protection mechanisms described below address the same vehicle, while other protection mechanisms try to create a network behavior in which other vehicles will not interfere as well. Several method embodiments can be applied for the protection, including classification of safety messages to important (close) or non-important (far away in terms of distance from a self-vehicle), link profiling for predicting a safety message reception time, and identification of relevant antenna for safety message reception. The protection method may lower transmission power, block transmission or delay it.

Protection of a WiFi Channel from the V2X Safety Channel

A first method embodiment relates to protection of a WiFi channel from the V2X safety channel. A power-save function of scheme, included in the IEEE 802.11e standard (which is incorporated herein by reference in its entirety) and used typically to perform Bluetooth-to-WiFi co-existence, is leveraged herein to protect the WiFi channel. The WiFi channel enters a power-save mode before the expected periodic V2X safety message and leaves the power-save mode afterwards. With the enter-exit power mode operation, failure of WiFi operation during the safety message transmission does not affect the WiFi rate. WiFi has a rate-adaptation mechanism that decreases the rate whenever interference is observed. V2X transmission will result in interference in the WiFi operation, which in turn will reduce its rate. The goal of this protection method is to inform the WiFi modem that this interference is expected, for ignoring it and not reducing the rate.

As mentioned, V2X transmissions must take place from both antennas concurrently using TX diversity to assure 360° coverage. Therefore, the shared-antenna configurations and methods of use disclosed herein will always lead to blinding of the WiFi operation.

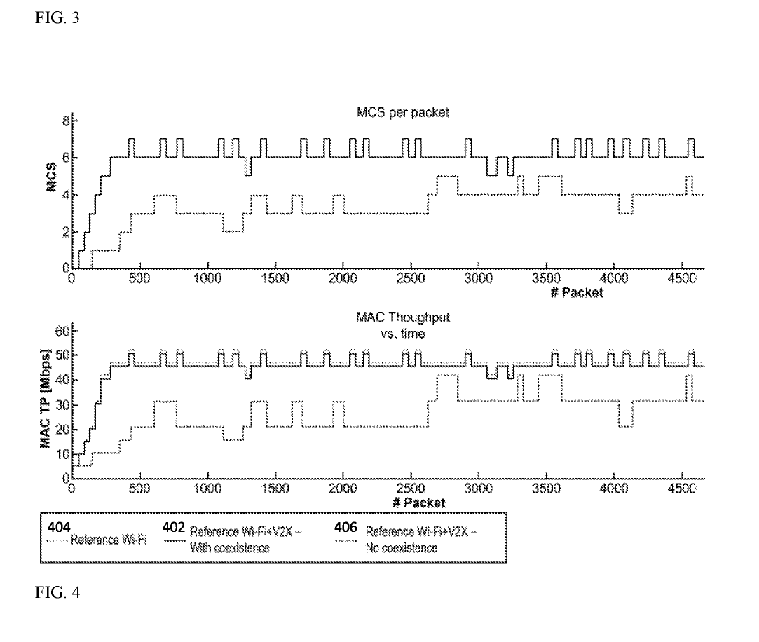

FIG. 3 illustrates a message flow in a communications power-save handshake scenario involving an apparatus such as apparatus 200 or 200′, according to an exemplary embodiment. Two different channels are supported: a V2X safety channel 300 with a transmit path 310 and a receive path 312, and a WiFi channel 304 with a transmit path 314 and a receive path 316.

As explained in FIGS. 2A-2C, concurrent reception of two channels is possible without interference. For example, a packet 322 is perfectly received over the V2X safety channel while data download 340 is performed over the WiFi channel. Interference occurs only during transmission, as a periodic V2X message 320 blinds the WiFi channel. Therefore, the WiFi channel is protected by entering a power-save state. A power saving (PS) message 330 is sent before the expected periodic V2X safety message transmission time, entering the WiFi channel into the power-save state 332, during which the WiFi access point (AP) is instructed not to transmit, meaning that the WiFi station (STA), which is the vehicle, is not expected to send ACK messages, to avoid blinding. The attribute “About to transmit safety” issued by the safety channel modem triggers the transmission of the PS message by the WiFi modem. This state is ended using a Power Save Polling (PSP) message 334. The PSP message is released once the attribute “Transmission on” changes back to False. During the power-save period, the access point is buffering messages, and a longer burst of data 344 can be expected once exiting the power-save mode, answered by a block-ACK message 346.

V2X safety transmissions occur 10 times per second for a short duration of 0.4-0.5 seconds. Hence, the impact of V2X transmission on WiFi throughput is negligible. Since WiFi transmission does not consider the interference during the V2X transmission, its rate is maintained.

FIG. 4 depicts simulation results of WiFi coexistence with V2X channel operation, according to an exemplary embodiment. The top graph shows MCS, a parameter defined by the IEEE 802.11 standard, as function of time/packet number. MCS represents the used modulation. A higher modulation allows a higher rate. The lower graph shows the MAC throughput (rate measured in Mbit/s) as function of time/packet number. It can be clearly seen that the application of the power-save handshake scenario in FIG. 3 prevents degradation of WiFi throughput in the presence of V2X transmissions 402, compared with WiFi throughput 404 alone, whereas severe degradation is evident without this mechanism 406.

Protection of the V2X Safety Channel from a WiFi Channel

A second method embodiment relates to the protection of the V2X safety channel from a WiFi channel. The protection of the V2X safety channel from WiFi transmissions is more complex, since WiFi transmissions are more frequent, V2X receive packets arrive unexpectedly and there is no way to stop other V2X transmitters in vicinity. V2X messages are safety critical, and their reception is more important than WiFi data. The reception probability (90%) is defined by specification and will be tested by regulation (certification). The reception sensitivity (−92 dBm) is hard to maintain during WIFI transmissions, and in most cases also when other devices transmit in proximity.

Several mechanisms can be implemented to support the certification requirement:
Low ACK transmission power
Dynamic TX antenna selection
Selective stoppage of WiFi operation
   These mechanisms complement each other, and all or a subset of such mechanisms can be implemented.

### Low ACK Transmission Power

Typically, WiFi transmits ACK at maximal power. The reasoning is that a lost ACK message will require retransmission of a much longer message, thus reducing link utilization. While this argument is true, it should be remembered that ACK is transmitted using BPSK modulation, while longer packets use higher modulation and their longer length increases their error probability. For that reason, an ACK message can be transmitted at lower power relative to the modulation signal-to-noise (SNR) gap, i.e. the difference between the required SNR for reception of each modulation (i.e. the difference in the SNR of signals at the two different modulations). For example, if data messages are received with MCS 3 (16-QAM) and ACK is transmitted using MCS 0 (BPSK), then transmit power can be lowered by 8 dB, while still having the same receive probability as that of a data message. Some spare transmission power needs (for reliable operation) to be increased, for example by 2 dB. Using the same example, the ACK transmit power can be lowered by 6 dB. The power reduction is translated instantly into lower blinding of the V2X channel in the same vehicle or in vehicles in proximity.

### Dynamic Transmission (TX) Antenna Selection

WiFi transmission can take place from one antenna, without applying diversity, since it needs to reach just the access point and not reach 360° around the vehicle. The common guideline of antenna selection is sending from the antenna of which received messages have the highest power. However, in embodiments disclosed herein, this practice may be broken if the antenna that received the lower power is still usable for transmission, and it is preferable from a V2X protection perspective. V2X preference (preferred antenna for transmission for mitigating V2X interference) depends on current reception or expected reception, as learned from the previous 100 ms cycle of a V2X channel.

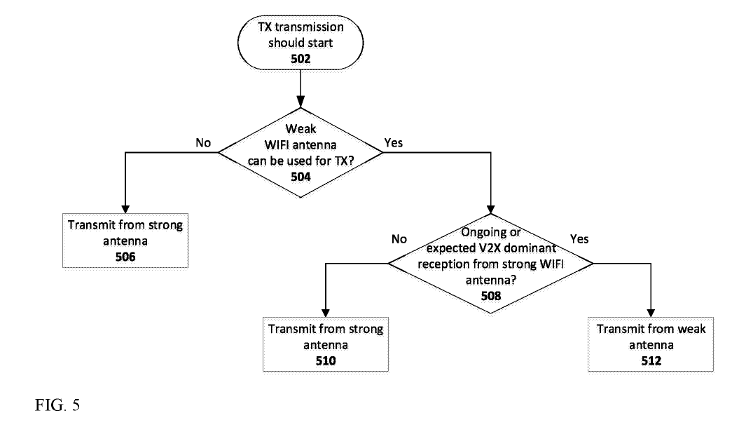

FIG. 5 illustrates a flow diagram of WiFi TX antenna selection according to an exemplary embodiment. Operation begins at step 502 where WiFi TX transmission begins. In step 504, a check checks if the antenna with the weak receive WiFi signal can be used for transmission. For that purpose, several conditions can be checked, such as maximal gap between the weak antenna and the strong one, for example, mandating maximal gap of 10 dB between the weak antenna and the strong one. Another condition is mandating mitigated receive energy in the weak antenna, which should be at least 3 dB BPSK sensitivity, for assuring successful ACK transmission. If the check result is No (i.e. the weak antenna cannot be used), then operation continues from step 506, where the antenna that received the strong WiFi signal is used for transmission.

If the check result in 504 is Yes, then operation continues to step 508. A check is made if an ongoing V2X reception is dominated by the strong WiFi antenna, or if such reception is expected. The attributes “Antenna preferred for V2X operation” and “Protected reception is expected” carry the needed information from the safety channel modem for the WiFi modem to support this decision. Reception expectation is based on profiling V2X reception from last cycle, meaning last 100 ms cycle. To achieve that, the received V2X power is recorded for both antennas for the last 100 ms. Antenna is declared as dominate if the received signal is 3 dB or more higher than the second one, and the energy of the second antenna is lower than −85 dBm. If the answer is no, meaning the strong WIFI antenna isn't the dominant one for V2X reception, then operation continues to step 510, where transmission takes place from the strong antenna. Otherwise, the operation continues to step 512, where transmission takes place from the weak antenna.

### Selective Stoppage of WiFi Operation

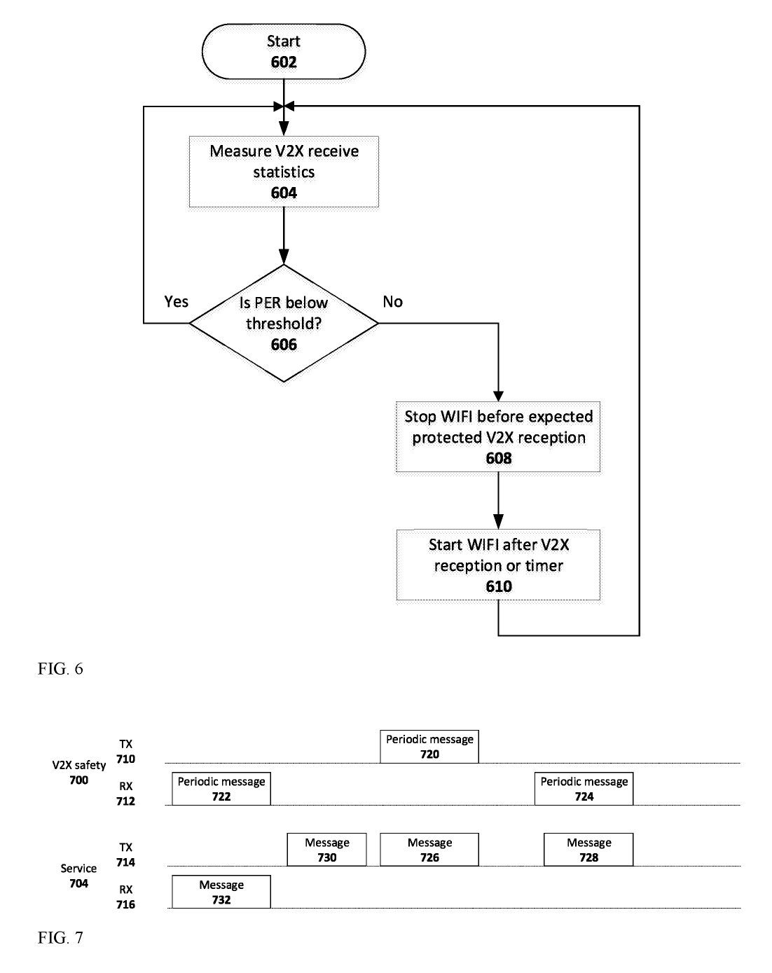

V2X performance needs to be assured. If V2X reception degrades beyond the level (“limit”) allowed by regulation, then WiFi transmission should be stopped to prevent more failures. The stoppage can be done immediately upon detection of degraded V2X performance below the limit until the V2X reception improves (i.e. exceeding 90%), or selectively before expected reception. Constant blocking of WiFi transmission makes no sense in the case of, for example, the V2X network being not busy, and, for example, if only 10 equipped vehicles are in vicinity of a self-vehicle, occupying together 5% of the wireless channel. The blocking may be more sophisticated, considering the distance of the vehicle, for example a far vehicle which is irrelevant or a near energy with high energy can be blocked. Such more sophisticated blocking is illustrated with reference to FIG. 6.

FIG. 6 illustrates a flow diagram of selective stoppage of WiFi operation with selective stoppage, according to an exemplary embodiment. Operation begins at step 602. Operation moves to step 604, where the statistics of V2X reception are measured. The measurement may include for example collection of statistics about a link, which includes link busy ratio, packet error rate (PER) PER per distance, etc. Those are provided by the attributes “Total Packet Error Rate” and “Packet Error Rate of vehicles inside protection radius” provided by the safety channel modem to the WiFi modem. The measurement duration needs to be sufficient to collect enough statistics, for example 20 messages. The measurement can, for example, relate only to vehicles within approximately a 300 meters range. In step 606, a check is made if the value of a parameter such as PER is below a threshold, for example under 10%. If No, (PER is below the threshold), operation returns to step 604. If Yes (PER is above the threshold) the operation continues to step 608. WiFi operation is stopped before an expected reception that deserves protection. “Expected reception” is predicted using the history of reception in a previous (100 ms before) cycle. Vehicles that deserve protection are those within range, such as 300 meters, and with low received energy, for example lower than −82 dBm. That way, WiFi operation stoppage is used only when absolutely needed. In step 610, WiFi operation is restarted after the V2X reception is completed, or after some time has passed, for example 1 ms. Operation returns to step 604.

Protection of the V2X Safety Channel from a V2X Service Channel

A third method embodiment relates to protection of the V2X safety channel from a V2X service (non-safety) channel. This relates to either protection of reception of safety messages from transmission in a non-safety V2X channel or channels, or protection of the reception of non-safety V2X channel or channels from transmission in the V2X safety channel. A V2X service channel has several features distinct from those of a WiFi channel, calling for a different set of protection mechanisms. The differences include:
A V2X service channel does not have a stop mechanism like a WiFi channel.
A V2X service channel has bigger impact on the V2X safety channel, as the bands are closer;
A V2X service channel has higher importance than a WiFi channel, since it carries vehicle related data;
A V2X service channel is expected to carry lower bandwidth than a WiFi channel, because a service channel serves multiple vehicles that all share the bandwidth, using semi-periodic messages, while WiFi data is transmitted/received with more bursts.

The suggested scheme for protection of the V2X safety channel from a V2X service channel is to transmit the V2X safety and service channels concurrently. Consequently, all receivers will have a low power difference between the two channels, capable of receiving both. The scheme limits the maximal service channel bandwidth, since the safety channel is rarely transmitted, hence requiring to extend the transmission to two more cases: expected inactive periods of V2X receive, and transmission of close neighboring vehicles, which are not using their opportunity to transmit the safety channel.

FIG. 7 illustrates a message flow of V2X safety and service channels, according to an exemplary embodiment. The flow is depicted from the point-of-view of a single self-vehicle, where the receive channels include messages transmitted by multiple vehicles in proximity. The self-vehicle is expected to send a periodic safety message 720. At the exact same time as that of the safety message transmission, the self-vehicle uses this opportunity (the transmission of safety message) to send an additional service message 726 over the service channel. If the service channel message is longer than the safety message, then fragmentation can be applied to prevent interference with following messages.

A received message 722 is accompanied by a service message 732 that was sent by the same vehicle (a vehicle other than the self-vehicle. However, the vehicle transmitting a safety message 724 did not send a service message. For that reason, the self-vehicle uses this opportunity (i.e. the fact that another vehicle did not send a service message, therefore leaving some free slot) to send a service message 728. It is important to note that the receive power of message 724 is high to ensure that other vehicles will receive the two messages 724 and 728 at similar power. To prevent collisions, it is important that fairness is applied at the transmission slot of message 728, i.e. not letting one vehicle to occupy all the bandwidth and letting other vehicles to transmit as well. In addition, since the safety channel was profiled (i.e. its activity over time was learned) a message 730 can be transmitted at the time the safety channel is expected to be empty.

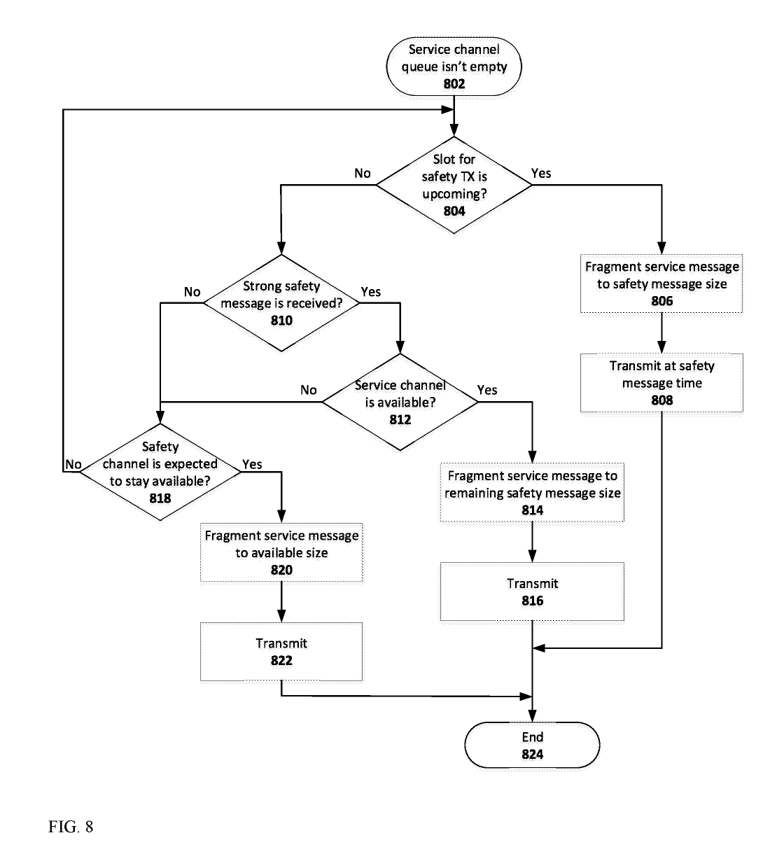

FIG. 8 illustrates a flow diagram of V2X service channel transmission according to an exemplary embodiment. Operation begins at step 802, when the service channel queue is not ready. Operation then continues from step 804, which checks if a slot for safety transmission is upcoming, as provided by the attribute “About to transmit safety”. A parameter defines the time distance toward the slot. For example, it may be wise to wait 2 ms for the next step 806, just because it is the optimal transmission opportunity. If the slot is upcoming, operation continues from step 806, where a service channel packet size is fragmented to align with a safety message size. The fragmentation considers the expected duration of the safety channel, as provided by the attribute “Expected transmission duration”, and the modulation used for service channel transmission. Obviously, fragmentation is not needed if the transmission duration of the service message is shorter than that of the safety message. In that case, the modulation of the service channel message may be reduced for sending the message over a longer duration. The operation continues to step 808, where the message is transmitted exactly when transmission of a safety message begins. If all vehicles follow this process, it would be assured that the service channel is available. The operation ends at step 824.

If the check of step 804 is negative, meaning no safety transmission is upcoming, then operation continues to step 810, which checks if a strong safety message is received, as provided by the attribute “Strong packet is received”. A strong message is defined as a message with a RSSI value above a certain threshold, for example −55 dBm. If yes, then operation continues from step 812, which checks the service channel is available. This is determined by the CCA status of the service channel. The check allows sufficient time (e.g. 16 μsec) for the CCA indication to rise (become positive). If it rises, operation continues to step 814. As explained in step 806, fragmentation is performed. Here, the packet length is taken from the received safety message, available through the attribute “Duration of current received packet”, deducting from it the time already consumed in the detection process. Transmit is performed at step 816. Here, multiple devices might transmit. Therefore, the random back-off procedure (a standard IEEE 802.11 mechanism) must be activated, and counting only at legitimate transmission opportunities to assure fairness. The operation ends at step 824.

If either of the checks of step 810 or 812 were negative, operation continues to step 818, which checks if the safety channel is expected to stay available. The check uses the profiling of a previous cycle, as explained in step 604. The check is positive only if no energy was detected. In that case, operation continues from step 820, where packet is fragmented, if needed, meaning if spare time isn't sufficient to send the entire message. The transmission takes place at step 822. The operation ends at step 824.

The various features and steps discussed above, as well as other known equivalents for each such feature or step, can be mixed and matched by one of ordinary skill in this art to perform methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

It is appreciated that certain features of the invention, which are, for clarity, described in the context of separate embodiments or example, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Citation or identification of any reference in this application shall not be construed as an admission that such reference is available as prior art to the present application.

What is claimed is:

1. A method, comprising:
a) in a vehicle, activating two communication channels; and
b) mitigating interference between the two channels when the two channels operate concurrently.

2. The method of claim 1, wherein the activating two communication channels includes activating a vehicle-to-everything (V2X) safety channel and a WiFi channel.

3. The method of claim 2, wherein the mitigating interference between the two channels includes protecting reception in the V2X safety channel from transmission in the WiFi channel.

4. The method of claim 2, wherein the mitigating interference between the two channels includes protecting reception in the WiFi channel from transmission in the V2X safety channel.

5. The method of claim 1, wherein the activating two communication channels includes activating a V2X safety channel and a V2X non-safety channel.

6. The method of claim 5, wherein the mitigating interference between the two channels includes protecting reception in the V2X non-safety channel from transmission in the V2X safety channel.

7. The method of claim 5, wherein the mitigating interference between the two channels includes protecting reception in the V2X safety channel from transmission in the V2X non-safety channel.

8. The method of claim 3, wherein the protecting reception in the V2X safety channel from transmission in the WiFi channel includes transmitting a WiFi ACK message at a power lower than a maximal possible power adjusted to a modulation signal-to-noise (SNR) gap.

9. The method of claim 3, wherein the protecting reception in the V2X safety channel from transmission in the WiFi channel includes selecting dynamically an antenna for WiFi channel transmission.

10. The method of claim 3, wherein the protecting reception in the V2X safety channel from transmission in the WiFi channel includes selectively stopping WiFi operation.

11. The method of claim 4, wherein the protecting reception in the WiFi channel from transmission in the V2X safety channel includes using a power-save mode in WiFi operation during an expected V2X safety channel transmission

12. The method of claim 6, wherein the protecting reception in the V2X non-safety channel from transmission in the V2X safety channel includes aligning a transmission in the V2X non-safety channel transmission with the transmission in V2X safety channel.

13. The method of claim 6, wherein the protecting reception in the V2X non-safety channel from transmission in the V2X safety channel includes aligning a transmission in the V2X non-safety channel with a V2X safety channel transmission of another vehicle that does not use an opportunity to transmit in the V2X non-safety channel.

14. The method of claim 6, wherein the protecting reception in the V2X non-safety channel from transmission in the V2X safety channel includes fragmenting a V2X non-safety channel transmitted packet to match a length of a V2X safety channel transmitted packet.

15. In a vehicle, an apparatus, comprising:
a) a first modem coupled operatively to a first communication channel;
b) a second modem coupled operatively to a second communication channel;
c) a first transceiver and a second transceiver coupled operatively to the first modem and used to perform RF modulation of the first communication channel to a first antenna and to a second antenna;
d) a third transceiver and a fourth transceiver coupled operatively to the second modem and used to perform RF modulation of the second communication channel to the first antenna and the second antenna; and
e) an interface for coordinating between the first and second modems to mitigate interference between the first communication channel and the second communication channel.

16. The apparatus of claim 15, wherein the first communication channel includes a vehicle-to-everything (V2X) safety channel, wherein the second communication channels includes a WiFi channel or a V2X non-safety channel and wherein the interface includes an attribute sent from the first modem to the second modem.

17. The apparatus of claim 16, wherein the mitigating interference between the two channels includes protecting reception in the V2X safety channel from transmission in the WiFi channel.

18. The apparatus of claim 16, wherein the mitigating interference between the two channels includes protecting reception in the WiFi channel from transmission in the V2X safety channel.

19. The apparatus of claim 16, wherein the mitigating interference between the two channels includes protecting reception in the V2X non-safety channel from transmission in the V2X safety channel.

20. The apparatus of claim 19, wherein the protecting reception in the V2X non-safety channel from transmission in the V2X safety channel includes aligning a transmission in the V2X non-safety channel transmission with the transmission in V2X safety channel.
